(19) United States
(12) Patent Application Publication
(10) Pub. No.: US 2025/0182053 A1
(43) Pub. Date: Jun. 5, 2025

(54) CLOSE NOTE SUMMARIZATION, MANAGEMENT AND MITIGATION

(71) Applicant: International Business Machines Corporation, Armonk, NY (US)

(72) Inventors: Harshit Kumar, Delhi (IN); Amar Prakash Azad, Bangalore (IN); Karan Bhukar, Jaipur (IN); Sachindra Joshi, Gurgaon (IN)

(21) Appl. No.: 18/527,250

(22) Filed: Dec. 2, 2023

(51) Int. Cl. G06Q 10/10; G06F 40/35; G06N 3/092; G06Q 10/0635

(52) U.S. Cl. CPC G06Q 10/103; G06F 40/35; G06N 3/092; G06Q 10/0635

(57) ABSTRACT

A composite conversation from a collaborative channel is obtained and independent conversations within the composite conversation are separated. An intent of each message in each of the independent conversations is determined and those messages with a same intent are clustered together to form artifact clusters. A summary for each artifact cluster is generated and the summaries of the artifact clusters are combined. A final coherent interaction summary is created based on the artifact clusters and a network-based computer system is reconfigured based on the final coherent interaction summary.

### BACKGROUND

The present invention relates generally to the electrical, electronic and computer arts and, more particularly, to computer and network management and remediation.

In the past, when a technical incident (such as a server failure) is reported by a client, Site Reliability Engineers (SREs), developers, and development and operations (DevOps) personnel would physically gather in a room. They would work together until the incident was resolved. With advancements in AIOps (artificial intelligence for Internet technology (IT) operations) and collaboration platforms, virtual rooms have replaced physical ones. These virtual rooms, created on conventional collaboration platforms, allow SREs, developers, DevOps personnel and the like to join a channel and communicate with each other to triage the issue(s). Once the incident is resolved, an incident number is generated, and a detailed description of the incident and the steps implemented for resolving the issue(s) are stored in an incident management instance. Due to time constraints, however, the close notes recorded by experts are often short or incomplete, rendering the valuable conversations held during incident remediation less effective for handling future incidents. In this regard, “close notes” refer to the summary prepared by the experts after resolution of the issue(s).

In addition to this situation, close notes are also quite pertinent for Change Requests (CR) or Pull Requests (PR) created on version control software. Currently, there is no provision for close notes on these platforms. Similar to incident resolution conversations, developers, program managers, team leads and the like use version control software to discuss new features or changes to existing features. The conversation data in CRs or PRs, however, tends to be noisy and often cannot be directly utilized by predictive algorithms, such as change risk assessment and code risk assessment algorithms.

### BRIEF SUMMARY

Principles of the invention provide systems and techniques for close note summarization, management and mitigation. In one aspect, an exemplary computer-implemented method includes the operations of obtaining, using at least one hardware processor, a composite conversation from a collaborative channel; separating, using the at least one hardware processor, independent conversations within the composite conversation; determining, using the at least one hardware processor, an intent of each message in each of the independent conversations; clustering together, using the at least one hardware processor, those messages with a same intent to form artifact clusters; generating, using the at least one hardware processor, a summary for each artifact cluster; combining, using the at least one hardware processor, the summaries of the artifact clusters; creating, using the at least one hardware processor, a final coherent interaction summary based on the artifact clusters; and reconfiguring a network-based computer system based on the final coherent interaction summary.

In one aspect, a computer program product comprises one or more tangible computer-readable storage media and program instructions stored on at least one of the one or more tangible computer-readable storage media, the program instructions executable by a processor, the program instructions comprising obtaining a composite conversation from a collaborative channel; separating independent conversations within the composite conversation; determining, using the at least one hardware processor, an intent of each message in each of the independent conversations; clustering together those messages with a same intent to form artifact clusters; generating a summary for each artifact cluster; combining the summaries of the artifact clusters; creating a final coherent interaction summary based on the artifact clusters; and reconfiguring a network-based computer system based on the final coherent interaction summary.

In one aspect, an apparatus comprises a memory and at least one processor, coupled to the memory, and operative to perform operations comprising obtaining a composite conversation from a collaborative channel; separating independent conversations within the composite conversation; determining an intent of each message in each of the independent conversations; clustering together those messages with a same intent to form artifact clusters; generating a summary for each artifact cluster; combining the summaries of the artifact clusters; creating a final coherent interaction summary based on the artifact clusters; and reconfiguring a network-based computer system based on the final coherent interaction summary.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
improvements to the technical field of computer system and network incident detection and mitigation by analyzing communications between experts to identify and summarize incident resolution steps, and facilitate mitigation of future incidents;
improvements to the technical field of computer system and network incident detection and mitigation by generating close notes that are more complete than manually generated close notes; and
effectively reducing the number of unnecessary utterances of a conversation that take place on collaborative channels during incident resolution to efficiently generate incident summaries.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1A is an illustration of a conventional (prior art) workflow for servicing an incident request;

FIG. 1B is an illustration of an example high-level workflow to service an incident request, in accordance with an example embodiment;

FIG. 2 is an illustration of an example workflow to service an incident request, in accordance with an example embodiment;

FIG. 3 is an illustration of a first sample issue remediation conversation, in accordance with an example embodiment;

FIGS. 4A and 4B are an illustration of a second sample issue remediation conversation, in accordance with an example embodiment;

FIG. 5A is a workflow for an example close note system, in accordance with an example embodiment;

FIG. 5B is a block diagram of the intent detection model and cluster unit 512, in accordance with an example embodiment;

FIG. 6 is a flowchart for an example method for generating a summary guided by intents (such as symptom, action, investigation, resolution, and the like) of utterances from troubleshooting conversations, in accordance with an example embodiment;

FIG. 7 is a flowchart for an example method for incorporating feedback for improving the generation of summaries, in accordance with an example embodiment; and

FIG. 8 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

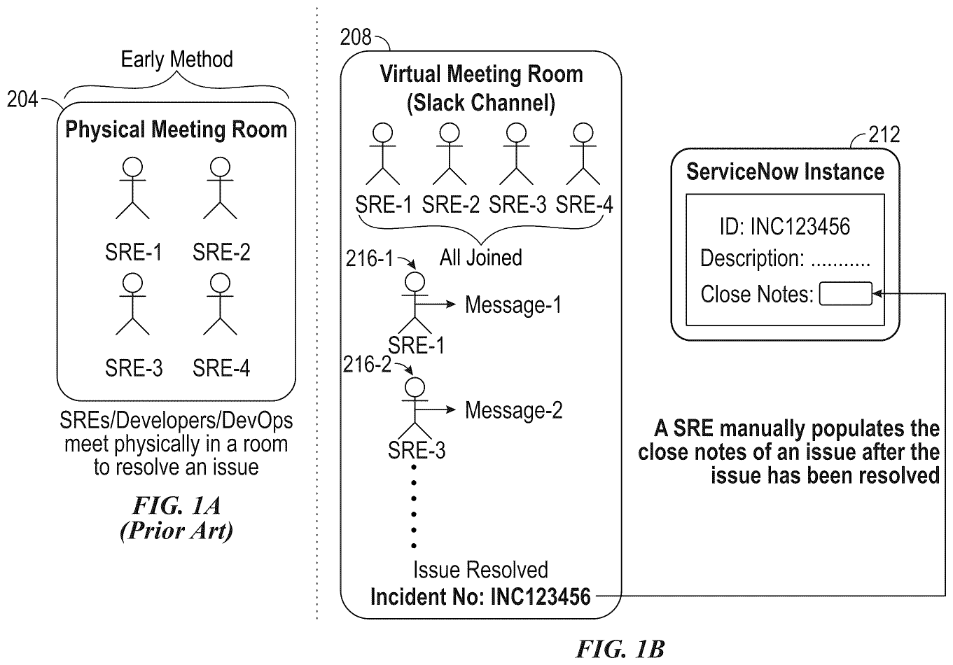

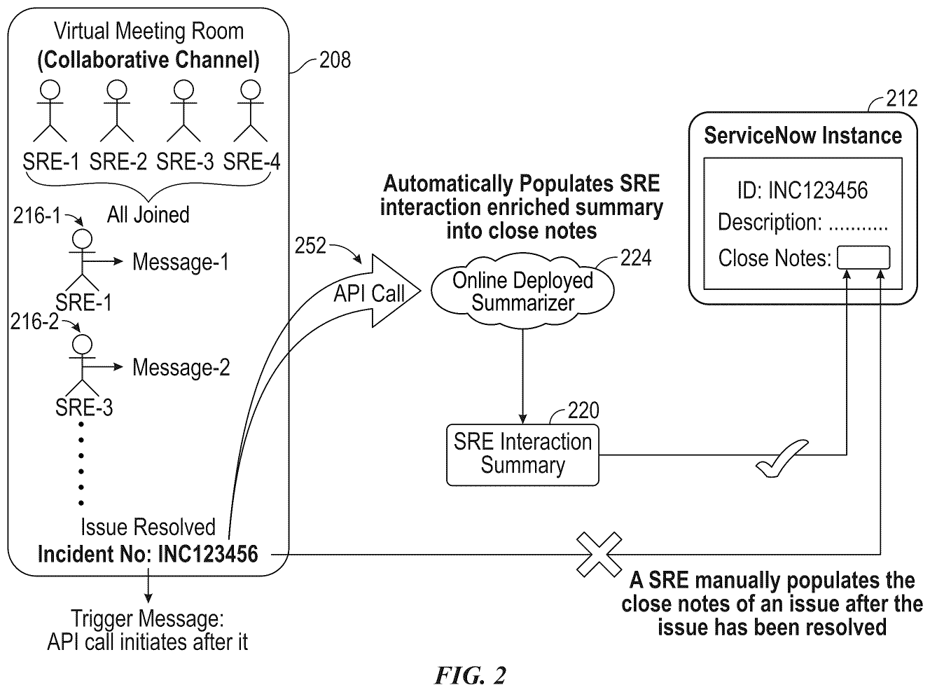

FIG. 1A is an illustration of a conventional workflow for servicing an incident request. Site Reliability Engineers (SREs) may gather, for example, in a physical meeting room 204 and communicate with each other to address a reported or otherwise detected incident (such as a server outage). The issue may be resolved through conversations between experts, such as the SREs, developers, development and operations (DevOps) experts, and the like.

FIG. 1B is an illustration of an example high-level workflow to service an incident request, in accordance with an example embodiment. A virtual Room 208 is established to enable experts, such as SREs, Developers, Development and Operations (DevOps) experts, and the like, to communicate via a network regarding a reported or otherwise detected outage. For example, a first SRE 216-1 and a second SRE 216-2 may issue messages to one or more of the experts assigned to the incident report. Once the issue is resolved, one or more of the experts manually populates the close notes that document, among other details, the solution that was implemented to resolve the incident. Such close notes may prove useful in addressing future similar incidents, in developing new systems or modifying existing systems, and the like. Element 212 is discussed below.

### Populating Close Notes of Incidents

### Scenario 1: Enrich Historical Incident Reports

Upon the arrival of an incident report, SREs 216-1, 216-2 come together in a physical room and/or on a collaboration platform to interact with each other for incident diagnosis and resolution. When a new incident is reported in an AIOps system, similar historical incidents that are available in the incident management instance are identified and used as a solution recommendation. The close notes field in the historical incident reports are expected to contain the steps implemented for addressing the incident. It has been observed, however, that close notes are often incomplete. In one example embodiment, close notes are automatically generated and populated in, for example, the incident report. In one example embodiment, these interactions are automatically summarized to facilitate the automatic population of the close notes.

### Scenario 2: Enrich Close Notes for Change Requests/Pull Requests

For development operations, a Change Request (CR) is the first step to propose a new feature, address a new feature and the like. For DevOps, a Pull Request (PR) is the first step to provide a description for a sub-part of a new feature or an existing feature. Developers, project managers, technical leads and the like typically interact to discuss the feature before approving it. Conventional AIOps have feature change risk assessment and code risk assessment tasks that assign a risk score to a new CR or PR. When assigning a risk score to a CR or PR, the conventional AIOps also provides explainability by quoting similar CRs or PRs. The conversation data of CRs or PRs are, however, often noisy and contain a lot of unnecessary text. In one example embodiment, a close note is automatically generated for a CR/PR. Similar to a close note for issue resolution, a close note is created for each CR/PR that summarizes the interactions of the participating experts. Close notes are automatically populated with a summary of the conversation between the developers, project managers, technical leads and the like. These close notes can also be used by the change risk assessment and code risk assessment prediction algorithms, and for explainability of the risk score.

In one example embodiment, the close notes are used for building a risk prediction model and for explaining the risk score of CR or PR (instead of using a CR or PR description). (It is noted that the conversations related to issue remediation that are observed on conventional collaboration platforms are very similar to the conversations on platforms related to a change/pull request.)

In general, conversations are of two types: task oriented or non-task oriented. Task oriented conversations are focused to achieve a certain task, such as flight booking, hotel reservation, and the like, whereas non-task-oriented conversations are based on a topic, such as the effects of pollution, sustainability, and the like. AIOps interactions between SREs 216-1, 216-2 are technical in nature to address a particular issue. AIOps interactions between SREs 216-1, 216-2 involve diagnostic steps or investigative steps and their outcomes, but may also contain chit-chats (inconsequential conversation) in between. It has been observed that 30-35% of such text is normal chit-chat. Therefore, a summary of AIOps interactions should contain diagnostic steps, investigative steps, problem statements, failed resolution attempts, and a final resolution that resolved the issue.

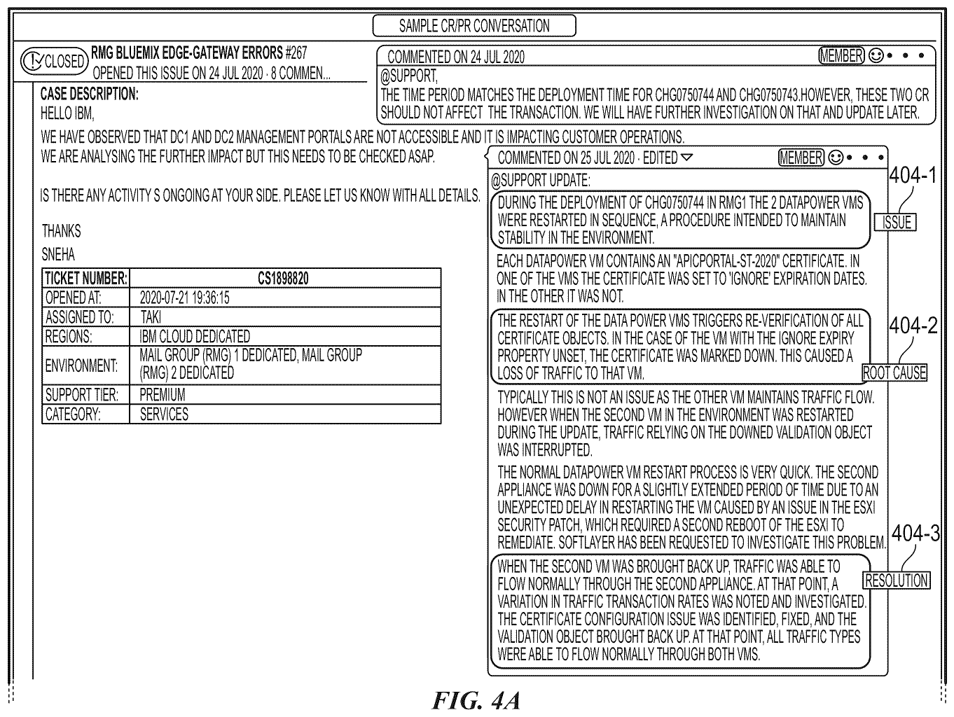

FIG. 3 is an illustration of a first sample issue remediation conversation, in accordance with an example embodiment. Initially, an issue is identified in a new pager duty alert 304-1. An expert 216-1, 216-2 issues a message 304-2 to investigate the issue (issue intent) and symptoms 304-3, 304-4, 304-5 (symptom intent) are discussed among the experts 216-1, 216-2. An action (action intent) that was implemented is identified via message 304-6 and the resolution details are shared in a message 304-7 (resolution intent). An example interaction summary 220 is illustrated at the bottom of FIG. 3.

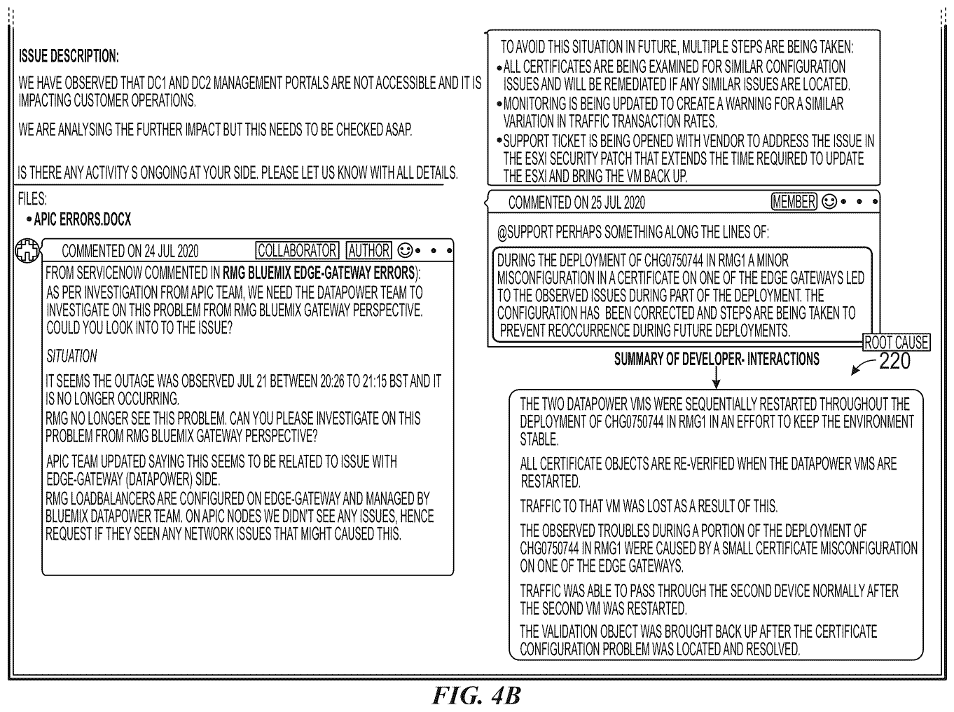

FIGS. 4A and 4B are an illustration of a second sample issue remediation conversation, in accordance with an example embodiment. Initially, an issue is identified in a message 404-1 (issue intent). An expert 216-1, 216-2 issues a message 404-2 identifying the root cause (root cause intent). The resolution details are shared in a message 404-3 (resolution intent). An example interaction summary 220 is illustrated at the bottom of FIG. 4B.

Issues with Close Notes Quality

Experts often face time constraints when writing close notes and such writing is often delayed relative to resolution of the incident, which results in inadequate details of the incident problem, the incident resolution, and the root cause being included in the close notes. In fact, the close notes are often very small and non-informative, such as “Problem resolved”, “Disk quota increased”, “Ticket closed”, and the like. On the other hand, the incident conversations of the SREs 216-1, 216-2 on collaborative platforms contain detailed information about symptoms, investigations, resolution steps, root causes, and the like. During creation of the close notes, SREs 216-1, 216-2 can be prompted with a succinct summary of each aspect of the conversation which can help SREs 216-1, 216-2 to quickly recall the incident details in a succinct form.

### Intents in a Conversation

In one example embodiment, an algorithm for intent-based conversation summarization of expert conversations is utilized to automatically generate an interaction summary. The conversations, which take place on collaborative channels, version control software, and the like, are different from everyday chit-chats. These conversations are task-oriented and specifically focused on achieving a particular objective. They are generally technical in nature and aimed at addressing specific issues. These conversations include steps for diagnosis, investigation, and resolution outcomes. In one example embodiment, four main types of intent messages present in these conversations are considered: symptom messages, action messages, investigation messages, and resolution messages. Other types of intent messages are also contemplated. These intent-detected messages are used to create the close notes.

By utilizing intent messages to prepare close notes, the number of unnecessary utterances of a conversation that takes place on collaborative channels during incident resolution can be effectively reduced. This approach is also applicable to CR (Change Request) and PR (Pull Request) conversations. It helps streamline the communication process and helps to ensure that the essential information is captured concisely and accurately in the close notes, eliminating the need for prolonged discussions.

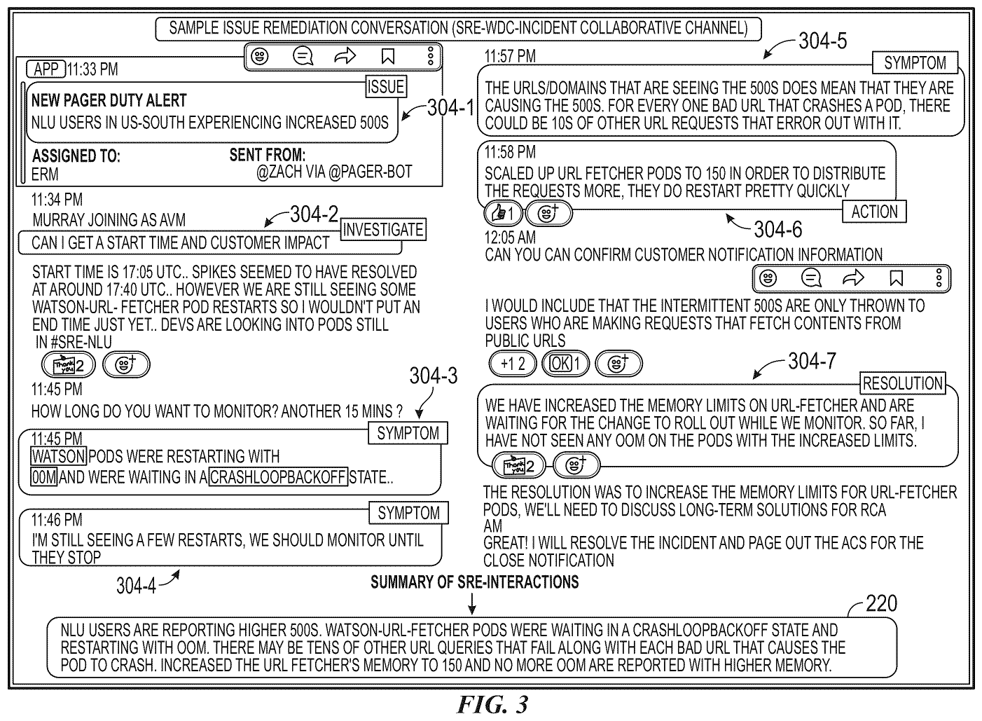

FIG. 2 is an illustration of an example workflow to service an incident request, in accordance with an example embodiment. As illustrated in FIG. 2, an indication of the issue being resolved triggers a message application programming interface (API) call 252 to an online deployed summarizer 224 that automatically generates an interaction summary 220 (such as an SRE interaction summary 220) and automatically populates the interaction summary 220 into the incident management instance 212 that corresponds to the resolved incident (such as incident no. 123456). In one example embodiment, an SRE 216-1, 216-2 is allowed to review and/or modify the interaction summary 220 either prior to or after population into the incident management instance 212. In one example embodiment, an SRE 216-1, 216-2 is allowed to submit a preliminary interaction summary and the online deployed summarizer 224 analyzes and/or modifies the submitted preliminary interaction summary.

In one example embodiment, a system automatically populates close notes for incident ticket creation. Once an incident is resolved and an incident number is generated, the system initiates an API call to a cloud-deployed close note generation algorithm. The entire incident conversation related to the incident is sent as input to the algorithm for summarization. Upon completion of the close note summary, another API call is made to an incident management instance. The previously generated summary is automatically populated into the close notes section of the incident management instance, ensuring a seamless and efficient process.

In one example embodiment, a system automatically populates close notes for CR and PR tasks: whenever a Change Request (CR) or Pull Request (PR) is closed on the version control software, an API call to a close note generation algorithm, such as a cloud-deployed close note generation algorithm, is triggered. The close note generation algorithm takes the entire conversation as input and generates a concise summary. Once the summary is prepared, it is automatically utilized to populate the close notes, streamlining the incident reporting process and ensuring that essential information is captured effectively. The close notes will also be utilized by predictive algorithms for change risk assessment and code risk assessment, as well as for explaining the risk score.

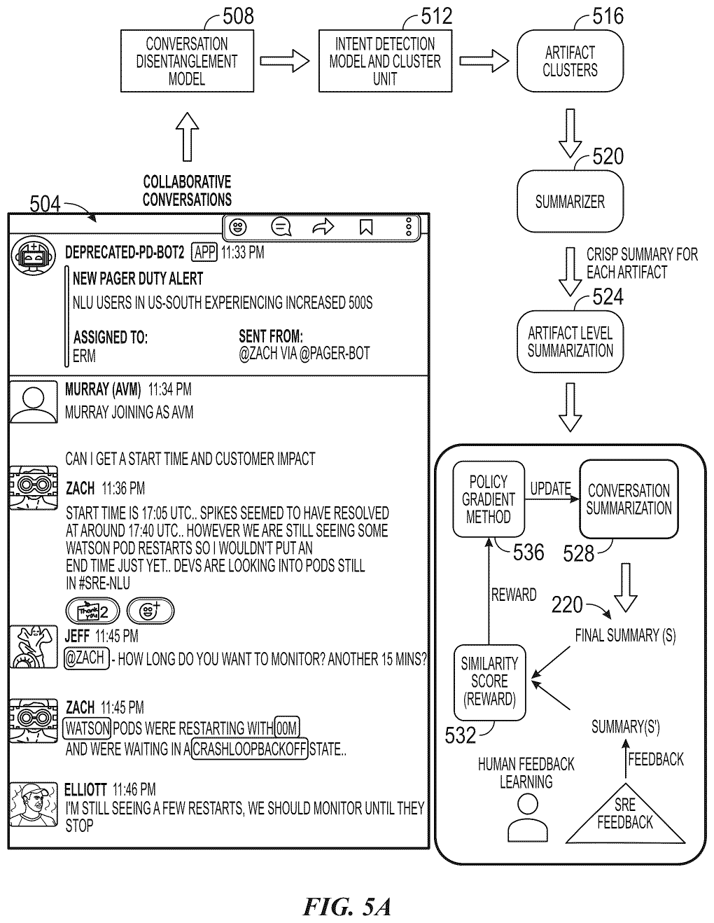

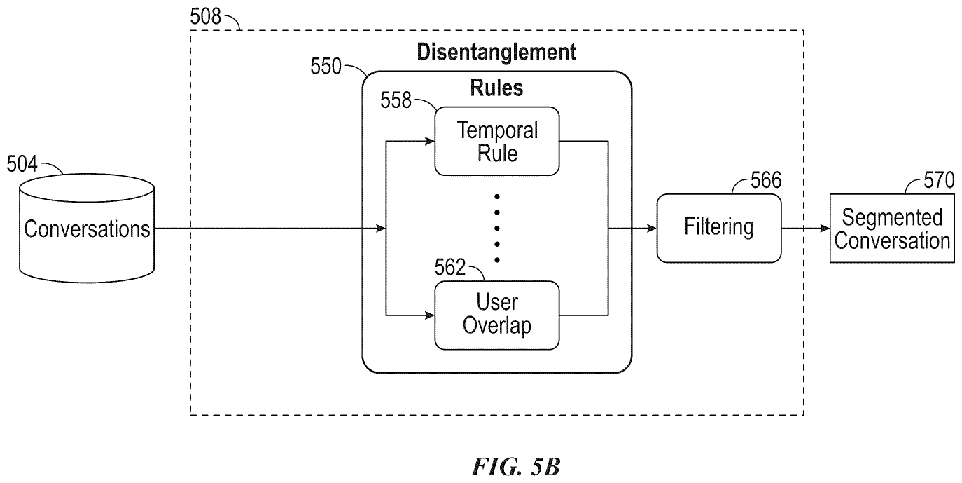

FIG. 5A is a workflow for an example close note system, in accordance with an example embodiment. In one example embodiment, a collaborative conversation 504 is processed by a conversation disentanglement model 508 to separate the independent conversations within the conversations 504. An intent detection model and cluster unit 512 is a neural network classifier trained and utilized to determine the intent behind each message of each independent conversation and to cluster together messages with the same intent to form intent clusters (also referred to as artifact clusters 516 herein). In one example embodiment, the neural network of the intent detection model and cluster unit 512 is trained with a training data set of labeled messages and produces a label for each input message that is selected from a finite set of labels. A transformer-based summarizer 520 is used to generate an artifact level summary 524 for each artifact cluster 516. The summaries 524 of the artifact clusters 516 are then combined (for example, concatenated together) and fed into a conversation summarizer 528 to create a coherent interaction summary 220 that encompasses the artifacts and intents. In one example embodiment, the conversation summarizer 528 is a bidirectional and auto-regressive transformer (BART). Feedback regarding the final coherent interaction summary 220 is received from an expert 216-1, 216-2 and is compared by a similarity score (reward) unit 532 with the interaction summary 220. (The similarity score (reward) unit 532 may be implemented as a cosine similarity, an edit distance and the like.) A policy gradient method 536 based on reinforcement learning updates the conversation summarizer 528 using a reinforcement learning-based approach to further improve the performance the summarizer 528.

FIG. 5B is a block diagram of the intent detection model and cluster unit 512, in accordance with an example embodiment. Collaborative channel conversations, which are typically multi-turn, multi-interlocuter and multi-thread, can entangle or mix different conversation sessions. The intent detection model and cluster unit 512 disentangles the sessions and messages, and generates the segmented conversations 570. In one example embodiment, each message within each conversation of the conversations 504 is processed by the conversation disentanglement model 508 where each message is compared to the criteria of a plurality of rules 550. For example, each message is processed to determine whether it meets the criteria of a temporal rule 558 which defines that two messages that occur within a predefined time period, such as ten seconds, are considered to be part of the same conversation. As illustrated in FIG. 5B, the message is also processed to determine whether it meets the criteria of a user overlap rule 562 which defines that a message that mentions the name of another conversant is considered to be part of the same conversation as that of the mentioned conversant. A filter 566 segments the processed messages based on the results of the rule processing. For example, messages that meet the criteria of a single rule 558, 562 are segmented according to the satisfied rule 558, 562. Messages that meet the criteria of a plurality of rules 558, 562 are segmented using the rule 558, 562 that has the highest priority of all the rules 558, 562 having criteria satisfied by the message.

Generally, given the teachings herein, the skilled artisan can implement the blocks of FIGS. 5A and 5B using, for example, software on a general purpose computer. Rules/filters can be implemented, for example, with high-level computer code using comparison statements and/or other logic. Data can be stored in databases, data files, or other known types of data structures. Machine learning components (including, but not limited to, transformer-based systems, reinforcement learning, etc.) in addition to being implemented in software on a general purpose computer, could be implemented in software on a special-purpose computer such as one using graphical processing units (GPUs) or with a hardware accelerator or an all-hardware based approach.

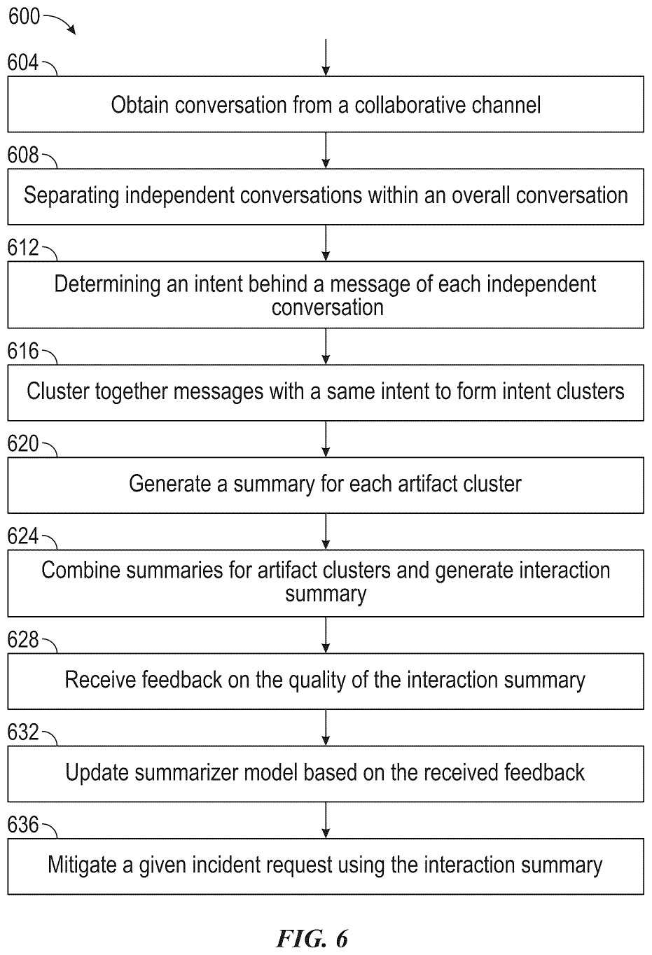

FIG. 6 is a flowchart 600 for an example method for generating a summary guided by intents (such as symptom, action, investigation, resolution, and the like) of utterances from troubleshooting conversations, in accordance with an example embodiment. In one example embodiment, a conversation from, for example, a collaborative channel, is obtained as input (operation 604). A conversation disentanglement model is employed to separate the independent conversations within the overall conversation (operation 608). For each message in each independent conversation, an intent detection model is utilized to determine the intent behind the message (operation 612). Messages with the same intent are clustered together, forming intent clusters (also referred to as artifact clusters) (operation 616). A generative pre-training transformer-based summarizer is used to generate a summary for each artifact cluster (operation 620). The summary of each artifact cluster are then combined and fed into a BART-based summarizer to create a final coherent interaction summary 220 that encompasses all the artifacts and intents (operation 624). The prepared final coherent interaction summary 220 is presented to an expert 216-1, 216-2 to receive feedback on its quality (such as a good summary or a bad summary) (operation 628). The feedback submitted by the expert 216-1, 216-2 is incorporated into the underlying model using a Reinforcement Learning-based approach to further improve its performance (operation 632). A given incident request is mitigated using the interaction summary (operation 636). For example, an incident request regarding a server failure may be remedied by implementing resolution steps described in the interaction summary.

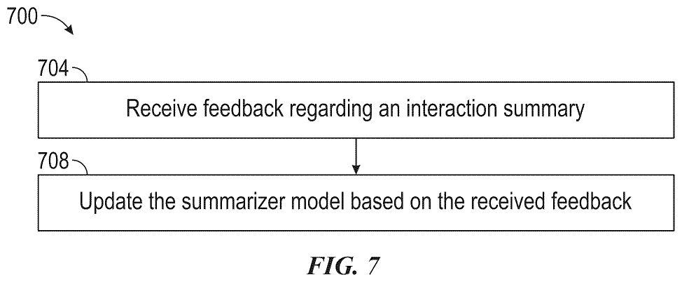

FIG. 7 is a flowchart 700 for an example method for incorporating feedback for improving the generation of summaries, in accordance with an example embodiment. In one example embodiment, once close notes or a CR/PR summary are automatically generated and updated in the incident management system, a user provides feedback about the quality of the incident summary 220 (operation 704). The feedback can be explicit or implicit. For example, if the user does not make any change to the generated incident summary 220, then it can be assumed that the incident summary 220 is satisfactory. However, if the user makes changes to the generated incident summary 220, then the changes can be taken as input to improve the underling summary generation algorithm. In one example embodiment, reinforcement learning with human feedback is used to update a model of the summarizer 224 based on the incident summary 220 corrected by the user (operation 708).

### Summary Generation

Consider a set D of N utterances of conversations, D={C\hat{ }1, C\hat{ }2, C\hat{ }3 . . . . C\hat{ }N}, and M utterances of a summary (Summ)={R1, R2, . . . , RM}. Each conversation utterance CAI and summary Ri itself is a sequence of utterances. A machine learning model, such as a generative pre-training transformer (GPT), a BART based model, and the like, is trained to predict a set of summary utterances for input conversation utterance D.

### Human Feedback to Improve Generated Summaries

For a given conversation C, an exemplary summary generation method generates a summary S. The SREs 216-1, 216-2 can provide explicit or implicit feedback for summary S. If the expert, such as SRE 216-1, 216-2, does not make any changes to the generated summary S, then it can be taken as a good summary. However, if the user makes changes to the generated summary S, the new summary is S′. A pretrained large language model is used to create embeddings e and e′ for S and S′, respectively, i.e., e=embed(S) and e′=embed (S″).

A similarity score is then computed between S and S′ as:

$$Sim - score ( S , {S}^{‵} ) = cosine - similarity ( e , {e}^{‵} )$$

The reinforcement learning algorithm uses a reward function R (S, S′)=Sim−score(S,S′). Given the teachings herein, any state-of-the-art policy gradient method may be used by the skilled artisan to maximize the reward function R (S, S′), and the summary generation method model may be updated to produce summaries in accordance with the summaries provided by the SRE 216-1, 216-2.

Given the discussion thus far, it will be appreciated that, in general terms, an exemplary method, according to an aspect of the invention, includes the operations of obtaining, using at least one hardware processor, a composite conversation from a collaborative channel (operation 604); separating, using the at least one hardware processor, independent conversations within the composite conversation (operation 608); determining, using the at least one hardware processor, an intent of each message in each of the independent conversations (operation 612); clustering, using the at least one hardware processor, together those messages with a same intent to form artifact clusters (operation 616); generating, using the at least one hardware processor, a summary for each artifact cluster (operation 620); combining, using the at least one hardware processor, the summaries of the artifact clusters; creating, using the at least one hardware processor, a final coherent interaction summary 220 based on the artifact clusters (operation 624); and reconfiguring a network-based computer system based on the final coherent interaction summary.

In one example embodiment, feedback on a quality of the final coherent interaction summary 220 is obtained (operation 628); and the obtained feedback is incorporated into an underlying model using a reinforcement learning-based approach to improve a performance of the underlying model (operation 632).

In one example embodiment, the generating of the summary for each artifact cluster is performed using a transformer-based summarizer.

In one example embodiment, the creating of the final coherent interaction summary 220 is performed using a bidirectional and auto-regressive transformer.

In one example embodiment, the separating of the independent conversations is performed using a conversation disentanglement model 508 and the determining of the intent of each message in each of the independent conversations is performed using an intent detection model.

In one example embodiment, a user is enabled to at least one of review and modify the interaction summary either prior to or after population of the interaction summary into an incident management instance.

In one example embodiment, one or more risk prediction models for change risk assessment and code risk assessment prediction algorithms are built based on the final coherent interaction summary 220; and explainability of risk scores is derived based on the final coherent interaction summary 220.

In one example embodiment, a message application programming interface (API) call 252 to a summarizer 224 that triggers the creation of the final coherent interaction summary is triggered; and the interaction summary 220 is automatically populated into an incident management instance 212 for a resolved incident that corresponds to the composite conversation.

In one example embodiment, a preliminary interaction summary is obtained from a user 216-1, 216-2, wherein the creating of the final coherent interaction summary 220 is based on the submitted preliminary interaction summary.

In one aspect, a computer program product comprises one or more tangible computer-readable storage media and program instructions stored on at least one of the one or more tangible computer-readable storage media, the program instructions executable by a processor, the program instructions comprising obtaining a composite conversation from a collaborative channel (operation 604); separating independent conversations within the composite conversation (operation 608); determining an intent of each message in each of the independent conversations (operation 612); clustering together those messages with a same intent to form artifact clusters (operation 616); generating a summary for each artifact cluster (operation 620); combining the summaries of the artifact clusters; creating a final coherent interaction summary 220 based on the artifact clusters (operation 624); and reconfiguring a network-based computer system based on the final coherent interaction summary.

In one aspect, an apparatus comprises a memory and at least one processor, coupled to the memory, and operative to perform operations comprising obtaining a composite conversation from a collaborative channel (operation 604); separating independent conversations within the composite conversation (operation 608); determining an intent of each message in each of the independent conversations (operation 612); clustering together those messages with a same intent to form artifact clusters (operation 616); generating a summary for each artifact cluster (operation 620); combining the summaries of the artifact clusters; creating a final coherent interaction summary 220 based on the artifact clusters (operation 624); and reconfiguring a network-based computer system based on the final coherent interaction summary.

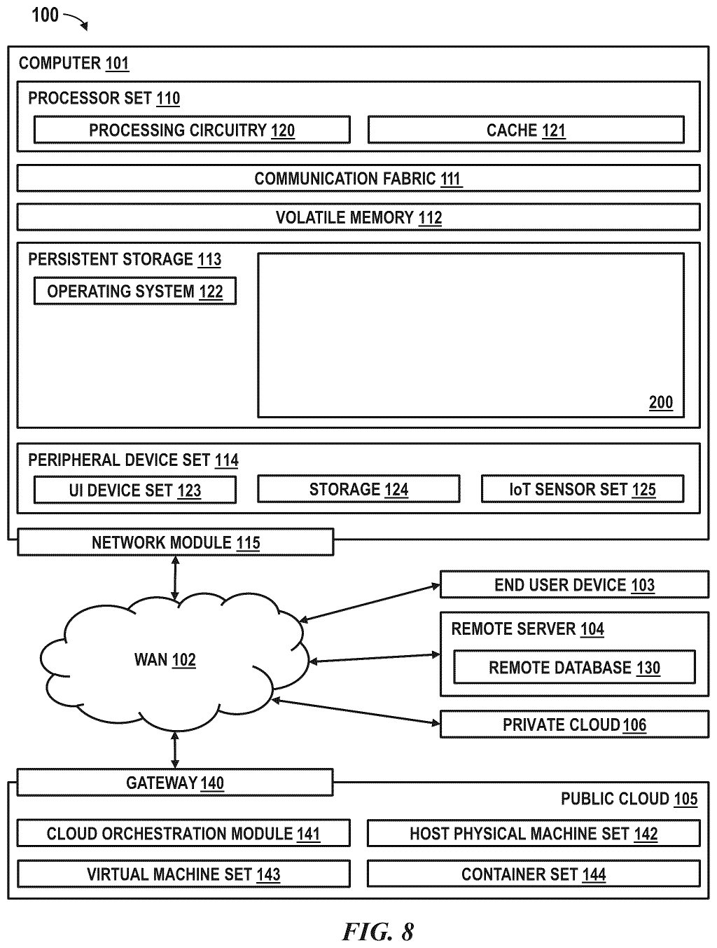

Refer now to FIG. 8.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as close note summarization, management and mitigation system 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
obtaining, using at least one hardware processor, a composite conversation from a collaborative channel;
separating, using the at least one hardware processor, independent conversations within the composite conversation;
determining, using the at least one hardware processor, an intent of each message in each of the independent conversations;
clustering together, using the at least one hardware processor, those messages with a same intent to form artifact clusters;
generating, using the at least one hardware processor, a summary for each artifact cluster;
combining, using the at least one hardware processor, the summaries of the artifact clusters;
creating, using the at least one hardware processor, a final coherent interaction summary based on the artifact clusters; and
reconfiguring a network-based computer system based on the final coherent interaction summary.

2. The method of claim 1, further comprising:
obtaining feedback on a quality of the final coherent interaction summary; and
incorporating the obtained feedback into an underlying model using a reinforcement learning-based approach to improve a performance of the underlying model.

3. The method of claim 1, wherein the generating of the summary for each artifact cluster is performed using a transformer-based summarizer.

4. The method of claim 1, wherein the creating of the final coherent interaction summary is performed using a bidirectional and auto-regressive transformer.

5. The method of claim 1, wherein the separating of the independent conversations is performed using a conversation disentanglement model and wherein the determining of the intent of each message in each of the independent conversations is performed using an intent detection model.

6. The method of claim 1, further comprising:
enabling a user to at least one of review and modify the interaction summary either prior to or after population of the interaction summary into an incident management instance.

7. The method of claim 1, further comprising:
building one or more risk prediction models for change risk assessment and code risk assessment prediction algorithms based on the final coherent interaction summary; and
deriving explainability of risk scores based on the final coherent interaction summary.

8. The method of claim 1, further comprising:
triggering a message application programming interface (API) call to a summarizer that triggers the creation of the final coherent interaction summary; and
automatically populating the interaction summary into an incident management instance for a resolved incident that corresponds to the composite conversation.

9. The method of claim 1, further comprising obtaining a preliminary interaction summary from a user, wherein the creating of the final coherent interaction summary is based on the submitted preliminary interaction summary.

10. A computer program product, comprising:
one or more tangible computer-readable storage media and program instructions stored on at least one of the one or more tangible computer-readable storage media, the program instructions executable by a processor, the program instructions comprising:
obtaining a composite conversation from a collaborative channel;
separating independent conversations within the composite conversation;
determining an intent of each message in each of the independent conversations;
clustering together those messages with a same intent to form artifact clusters;
generating a summary for each artifact cluster;
combining the summaries of the artifact clusters;
creating a final coherent interaction summary based on the artifact clusters; and
reconfiguring a network-based computer system based on the final coherent interaction summary.

11. The computer program product of claim 10, the program instructions further comprising:
obtaining feedback on a quality of the final coherent interaction summary; and
incorporating the obtained feedback into an underlying model using a reinforcement learning-based approach to improve a performance of the underlying model.

12. A system comprising:
a memory; and
at least one processor, coupled to said memory, and operative to perform operations comprising:
obtaining a composite conversation from a collaborative channel;
separating independent conversations within the composite conversation;
determining an intent of each message in each of the independent conversations;
clustering together those messages with a same intent to form artifact clusters;
generating a summary for each artifact cluster;
combining the summaries of the artifact clusters;
creating a final coherent interaction summary based on the artifact clusters; and
reconfiguring a network-based computer system based on the final coherent interaction summary.

13. The system of claim 12, the operations further comprising:
obtaining feedback on a quality of the final coherent interaction summary; and
incorporating the obtained feedback into an underlying model using a reinforcement learning-based approach to improve a performance of the underlying model.

14. The system of claim 12, wherein the generating of the summary for each artifact cluster is performed using a transformer-based summarizer.

15. The system of claim 12, wherein the creating of the final coherent interaction summary is performed using a bidirectional and auto-regressive transformer.

16. The system of claim 12, wherein the separating of the independent conversations is performed using a conversation disentanglement model and wherein the determining of the intent of each message in each of the independent conversations is performed using an intent detection model.

17. The system of claim 12, the operations further comprising:
enabling a user to at least one of review and modify the interaction summary either prior to or after population of the interaction summary into an incident management instance.

18. The system of claim 12, the operations further comprising:
building one or more risk prediction models for change risk assessment and code risk assessment prediction algorithms based on the final coherent interaction summary; and
deriving explainability of risk scores based on the final coherent interaction summary.

19. The system of claim 12, the operations further comprising:
triggering a message application programming interface (API) call to a summarizer that triggers the creation of the final coherent interaction summary; and
automatically populating the interaction summary into an incident management instance for a resolved incident that corresponds to the composite conversation.

20. The system of claim 12, the operations further comprising obtaining a preliminary interaction summary from a user, wherein the creating of the final coherent interaction summary is based on the submitted preliminary interaction summary.
